(19) United States
(12) Patent Application Publication
(10) Pub. No.: US 2015/0009047 A1
(43) Pub. Date: Jan. 8, 2015

(54) METHOD AND APPARATUS FOR VEHICLE PARKING SPACES MANAGEMENT USING IMAGE PROCESSING

(71) Applicants: Mordechai ASHKENAZI, Panama city (PA); Ezra DAYA, Petah Tikva (IL)

(72) Inventors: Mordechai ASHKENAZI, Panama city (PA); Ezra DAYA, Petah Tikva (IL)

(21) Appl. No.: 13/935,495

(22) Filed: Jul. 4, 2013

(51) Int. Cl. G08G 1/14

(52) U.S. Cl. CPC G08G 1/144
USPC 340/932.2

(57) ABSTRACT

The subject matter discloses a method for vehicle parking spaces management using image processing, comprising: obtaining one or more images of a plurality of parking spaces; segmenting the image of the one or more images to represent a parking space per segmented image; detecting parked vehicles in the segmented image using image processing; obtaining data from one or more additional sources related to the occupancy status of the plurality of parking spaces; and evaluating the occupancy status of the parking space of the plurality of parking spaces based on the parking vehicle detection and the obtained data from the one or more additional sources.

### FIELD OF THE INVENTION

The present invention is related to the field of Image processing and in particular to vehicle parking spaces management using image processing.

### BACKGROUND

Vehicle parking is an essential component of the transportation system. Vehicles must park at every destination. A typical vehicle is parked most of the day, and uses several parking spaces each week. The lack of parking spaces in densely populated metropolitan areas is a cause for wastage of economic and environmental resources. The task of seeking for a vacant parking space in close vicinity to the vehicle driver's destination may consume a considerable amount of time and energy. In many cases a vacant parking space may be available but its exact location may not be known to the vehicle driver. Moreover, in many cases, the vacant parking space characteristics such as, residents parking restrictions, maximum parking time restrictions and cost per hour may also not be known to the vehicle driver. However, information regarding the vacant parking space location and said vacant parking space characteristics is essential for efficient vehicle parking. There is thus a need in the art for method and apparatus for vehicle parking spaces management using image processing.

### SUMMARY OF THE INVENTION

The disclosure relates to vehicle parking spaces management using image processing, the method comprising: obtaining one or more images of a plurality of parking spaces; segmenting the image of the one or more images to represent a parking space per segmented image; detecting parked vehicles in the segmented image using image processing; obtaining data from one or more additional sources related to the occupancy status of the plurality of parking spaces; and evaluating the occupancy status of the parking space of the plurality of parking spaces based on the parking vehicle detection and the obtained data from the one or more additional sources. Within the method, the one or more images are optionally obtained from one or more street cameras and/or from one or more satellite cameras. Within the method, the data from the additional sources related to the occupancy status of a plurality of parking spaces is optionally obtained from a computerized application, wherein data in the computerized application is provided from users of the computerized application. Within the method, the data from the additional sources related to the occupancy status of a plurality of parking spaces is optionally obtained from one or more vehicle parking payment systems or from a plurality of parking sensors. The method may further comprise assigning weights to the one or more street cameras and to the one or more satellite cameras. The method may further comprise assigning weights to the obtained data from the one or more additional data sources. The method may further comprise generating occupancy confidence score based on the parking vehicle detection and the obtained data from the one or more additional data sources; said confidence score represents the probability estimation that the parking space is occupied. The method may further comprise. Within the method, the occupancy confidence score generation is optionally based on the weights assigned to the one or more street cameras, to the one or more satellite cameras and to the one or more additional data sources. The method may further comprise generating an occupancy decision based on the occupancy confidence score. The method may further comprise updating the occupancy status in a metropolitan area parking spaces database based on the occupancy decision. The method may further comprise vehicle information extraction using image processing. The method may further comprise updating the metropolitan area parking spaces database with the extracted vehicle information. The method may further comprise receiving a parking space request from an end user of a mobile computing device; locating one or more vacant parking spaces in the metropolitan area parking spaces database to be recommended to the end user of the mobile computing device; and transmitting parking space information to the mobile computing device, said parking space information comprises data regarding the located vacant parking space. Within the method the location of the vacant parking space is optionally based on locating the nearest vacant parking space to the destination location of the end user. Within the method the location of the vacant parking space is optionally based on the end user's expected parking duration, the end user's parking restrictions and the end user's parking space cost limitation. The method may further comprise obtaining parking occupancy statuses, parked vehicles information and parking space restriction information; and detecting parking violations based on the said parking occupancy statuses, parked vehicles information and parking space restriction information. The method may further comprise issuing parking violation enforcement message based on the detection of the parking violation. The method may further comprise issuing a traffic ticket based on the detection of the parking violation.

### BRIEF DESCRIPTION OF THE DRAWINGS

The present disclosure will be understood and appreciated more fully from the following detailed description taken in conjunction with the drawings in which corresponding or like numerals or characters indicate corresponding or like components. Unless indicated otherwise, the drawings provide exemplar), embodiments or aspects of the disclosure and do not limit the scope of the disclosure. In the drawings:

FIG. 1 shows a schematic illustration of metropolitan area parking data sources, according to exemplary embodiments of the disclosed subject matter;

FIG. 2 shows a method for analyzing vehicle parking data from various data sources according to exemplary embodiments of the disclosed subject matter:

FIG. 3 shows a metropolitan area parking spaces database structure, according to exemplary embodiments of the disclosed subject matter;

FIG. 4 shows a method for vehicle parking guidance, according to exemplary embodiments of the disclosed subject matter; and

FIG. 5 shows a method for managing vehicle parking violations, according to exemplary embodiments of the disclosed subject matter.

### DETAILED DESCRIPTION

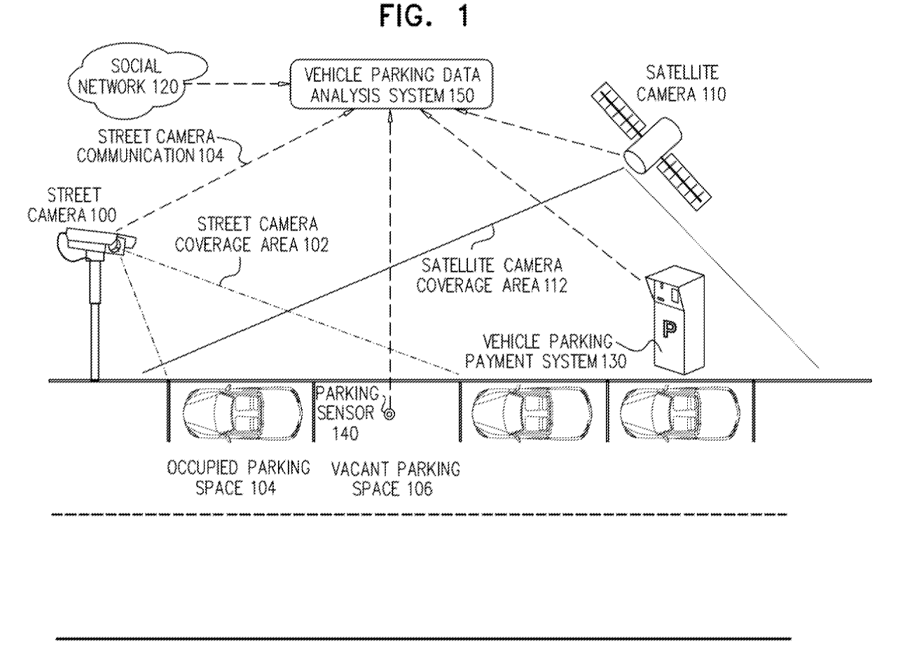

Reference is made to FIG. 1 which shows a schematic illustration of metropolitan area parking data sources, according to exemplary embodiments of the disclosed subject matter.

Street camera 100 is a video camera that produces images of one or more parking spaces. Street camera 100 produces images that include occupied parking space 104 and vacant parking space 106 according to street camera coverage area 102. The images are transmitted for analysis by vehicle parking data analysis system 150. The images may be transmitted using means of digital communication such as wireless data network, landline data network or by intermediate internet site. A plurality of street cameras may be stationed throughout the metropolitan area. The street cameras may be set up and deployed exclusively for the purpose of vehicle parking management, alternatively video cameras that were pre deployed for other purposes may also be used as street cameras for the purpose of vehicle parking management.

Satellite camera 110 is a satellite video camera that is located on a satellite. The satellite camera may produce a satellite image of all or part of the metropolitan area according to satellite camera coverage area 112. The satellite image is transmitted for analysis by the vehicle parking data analysis system 150. The video satellite image may be transmitted to the vehicle parking data analysis system through an intermediary terrestrial station. The intermediary terrestrial station may transmit the satellite image by wireless data network, landline data network or by intermediate internet site.

Social network 120 may be a computerized application such as vehicle parking social media application. Social network 120 may produce social network data that include information regarding parking spaces throughout the metropolitan area. The social network data may include parking spaces identifiers such as street address or spatial location coordinates. The social network data may also include the occupancy status and the confidence regarding the occupancy status of the parking spaces. The occupancy status may be provided by users of the vehicle parking social media application. The confidence regarding the occupancy status of the parking space may be produced by aggregating occupancy statuses, provided by users, regarding a specific parking space. The social network data may also include parking vehicles information such as vehicle manufacturer, vehicle model, vehicle color and the like. The social network data is transmitted for analysis by the vehicle parking data analysis system 150. It may be transmitted every predefined period of time, typically every 30 seconds, or in a push mode, upon change in one or more parking spaces occupancy status. The social network data may be transmitted using means of digital communication such as wireless data network, landline data network or by intermediate internet site.

Vehicle parking payment system 130 may be located on the street or in a central location without physical presence in the street. The vehicle parking payment system purpose is to collect and manage payments for parking spaces. Various payment methods such as cash payment, on spot credit card payment, telephone credit card payment, internet credit card payment and mobile computing devices payment applications may be applied. The vehicle parking payment system may generate vehicle parking payment system data regarding parking spaces. The generated vehicle parking payment system data may include parking spaces identifiers such as street address or spatial location coordinates or any other type of identifiers and the occupancy status of the parking spaces. In case that a parking space is occupied, the vehicle parking payment system data may also include the occupancy start time and the expected occupancy duration. The vehicle parking payment system data is transmitted for analysis by the vehicle parking data analysis system 150. The vehicle parking payment system data may be transmitted every predefined period of time, typically every 30 seconds, or in a push mode, upon change in one or more parking space occupancy status. The data may be transmitted using means of digital communication such as wireless data network, landline data network or by intermediate internet site.

Parking sensor 140 may be a weight sensor, a volume sensor, a laser sensor, a magnetic sensor or the like. The parking is sensor located in close vicinity to the vehicle parking space and designed to generate parking sensor data regarding the occupancy of the parking space. The parking sensor data may include parking spaces identifiers such as street address or spatial location coordinates or any other type of parking space identifier and the occupancy status of the parking spaces. In case that a parking space is occupied, the information may also include the occupancy start time. The generated parking sensor data is transmitted for analysis by the vehicle parking data analysis system 150. The information may be transmitted every predefined period of time, typically every 30 seconds, or in a push mode, upon change in one or more parking space occupancy status. The parking sensor data may be transmitted using means of digital communication such as wireless data network, landline data network or by intermediate internet site.

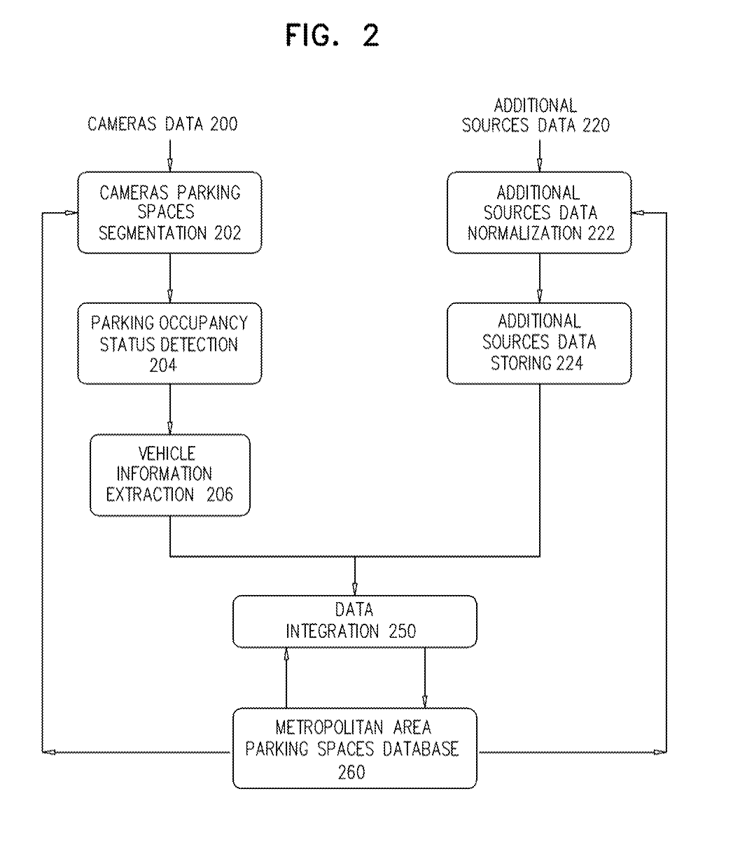

Reference is made to FIG. 2 which shows a method for analyzing vehicle parking data from various data sources, according to exemplary embodiments of the disclosed subject matter. The embodiment shown in FIG. 2 may be carried out by a system such as vehicle parking data analysis system 150 of FIG. 1.

Cameras data 200 is one or more images that may be obtained from cameras such as street camera 100 of FIG. 1. The cameras data 200 may also be obtained from satellite cameras such as satellite camera 110 of FIG. 1. The images are transferred for analysis and data extraction as shown in steps 202, 204 and 206.

Step 202 discloses segmenting images to parking space images. At this step images from cameras are segmented, producing a segmented image. Every segmented image represent a single parking space. The segmentation may be performed according to predefined parking spaces spatial boundaries that are associated with the cameras. The predefined parking spaces boundaries may be set in accordance to the coverage area of the cameras. Along with the parking space spatial boundary, predefined parking space IDs are also associated with the segmented images. The parking space IDs are associated in accordance with the metropolitan area parking spaces database 260. The metropolitan area parking spaces database includes a list of all of the managed parking spaces in the metropolitan area. Parking spaces on the list of managed parking spaces are associated with parking space attributes such as parking space ID, parking space location and the like.

Step 204 discloses detecting parking occupancy status. At this step the segmented images are analyzed using image processing techniques. The analysis purpose is to decide whether a parking vehicle appears in the segmented image or not. The analysis of the segmented images may be performed every predefined period of time, typically every 30 seconds. The detection of parking vehicle is based on object detection techniques such as edge detection, gradient matching. SIFT algorithm or the like. The analysis produces a parking vehicle detection confidence score. The parking vehicle detection confidence score represents estimation to the probability that the segmented image contains an image of a parking vehicle object. The parking vehicle detection confidence score is in the range of (0-1). Where 1 represents the highest probability that there is a parking vehicle object in the parking space and 0 represents the highest probability that the parking space is vacant.

The parking vehicle detection confidence score is compared to a predefined threshold. In case that the parking vehicle detection confidence score is higher than the predefined threshold then a parking vehicle is detected. In this case a parking vehicle detection signal is set to one. In case that the parking vehicle detection confidence score is lower than the predefined threshold then no parking vehicle is detected in the segmented image and the parking vehicle detection signal is set to zero. The parking vehicle detection confidence score and the parking vehicle detection signal are associated with the parking space ID and the segmented image. The parking space IDs, parking vehicle detection confidence scores and the parking vehicle detection signals of all of the segmented images are referred to herein as cameras extracted data.

Step 206 discloses extracting vehicle information from segmented images using image processing. Vehicle information such as vehicle manufacturer, vehicle model, vehicle color and the like, is extracted from segmented images that are associated with parking vehicle detection signals that are set to one. The extracted vehicle information is associated with the cameras extracted data. In addition, in some embodiments, the vehicle license plate number is also extracted from the segmented images that are associated with parking vehicle detection signals that are set to one and are associated with the cameras extracted data. The vehicle license plate number may be extracted using optical character recognition (OCR).

Additional sources data 220 may be obtained from social networks such as social networks 120 of FIG. 1. Additional sources data 220 may also be obtained from parking payment systems such as vehicle parking payment system 130 of FIG. 1. Additional sources data 220 may also be obtained from parking sensors such as parking sensor 140 of FIG. 1.

Step 222 discloses normalizing the additional sources data. The additional sources data identifiers of parking spaces may be spatial location coordinates, street address or any other type of identifiers. The parking space identifiers of the additional sources data are converted to parking space IDs in accordance with the metropolitan area parking spaces database 260. The conversion may be performed using predefined conversion tables or, for instance, by searching for matching spatial coordinates in the metropolitan area parking spaces database and extracting the parking space ID that is associated with the matched spatial coordinates. The additional sources data regarding the parking space occupancy of the parking spaces are normalized to the range of [0-1] where 1 represents an occupied parking space and 0 represents a vacant parking space. The normalized occupancy status is referred to herein as occupancy status confidence. The additional sources data may include information such as the occupancy start time and the expected occupancy end time of the parking space. This data is normalized to [HH:MM:SS] format in order to resemble the metropolitan area parking spaces database format. The additional sources data may also include information regarding the parking vehicles. This information may be normalized to vehicle manufacturer code, vehicle model code and vehicle color code using conversion tables. The normalized additional sources data may include the converted parking space ID, the occupancy status confidence, the normalized occupancy start time, the normalized expected occupancy end time, the normalized parking vehicle information and the like.

Step 224 discloses storing the normalized additional sources data in a local database. The local database structure resembles the metropolitan area parking spaces database structure.

Step 250 discloses integrating one or more data sources in order to evaluate the occupancy status of the parking spaces. The data sources may include the cameras extracted data which may originate from street cameras or satellite camera. The data sources may also include the normalized additional sources. The normalized additional sources may originate from social networks data, vehicle parking payment systems data or parking sensors data. Another input to step 250 is the metropolitan area parking spaces database 260. This database includes a list of all of the managed parking spaces in the metropolitan area. The parking spaces on the list of managed parking spaces are associated with parking space attributes such as parking space ID, parking space location, occupancy status, occupancy start time and the like. An iterative process of parking spaces occupancy status examination is performed. The iterative process generates an occupancy confidence score. The occupancy confidence score represents the probability that the parking space is occupied. The iterative process further generates a decision regarding the occupancy status of the parking spaces on the list of managed parking spaces. The occupancy status field of the parking space in the metropolitan area parking spaces database may be updated based on the occupancy decision. The occupancy confidence score and occupancy decision are based on the integration of information from all of the available data sources regarding a parking space ID. The occupancy decision may also take into account the parking vehicle detection confidence scores that are part of the cameras extracted data. For example, in some embodiments, the occupancy confidence score may be generated using the following formula:

$${OC}_{i} = 100 ( 1 - {log}_{2} ( 1 + \frac{1}{1 + {W}^{sc} {C}_{i}^{sc} + {W}^{sat} {C}_{i}^{sat} + {W}^{sn} {C}_{i}^{sn} + {W}^{p s} {C}_{i}^{p s} + {W}^{psen} {C}_{i}^{psen}} ) )$$

Wherein: OCᵢ may represent the occupancy confidence of the i-th parking space ID. OCᵢ is in the range of (0-1), where 1 represents the highest confidence and 0 represents the lowest confidence;

W^{sc} may represent a predefined assigned weight of the street cameras data source. The street cameras data source weight W^{sc} is in the range of (0-1), where 1 represents the highest weight and 0 represents the lowest weight;
Cᵢ^{sc} may represent the parking vehicle detection confidence score of the i-th parking space ID that is produced from street camera image at step 204;
W^{sat} may represent a predefined assigned weight of the satellite cameras data source. The satellite cameras data source weight W^{sat} is in the range of (0-1), where 1 represents the highest weight and 0 represents the lowest weight;
Cᵢ^{sat} may represent the parking vehicle detection confidence score of the i-th parking space ID that is produced from satellite camera image at step 204;
W^{sn} may represent a predefined assigned weight of the social networks data source. The social networks data source weight W^{sn} is in the range of (0-1), where 1 represents the highest weight and 0 represents the lowest weight;
Cᵢ^{sn} may represent the occupancy status confidence score of the i-th parking space ID obtained from the social network and normalized at step 222;
W^{ps} may represent a predefined assigned weight of the vehicle parking payment systems data source. The vehicle parking payment systems data source; weight Wₚₛ is in the range of (0-1), where 1 represents the highest weight and 0 represents the lowest weight;
Cᵢ^{ps} may represent the occupancy status confidence score of the i-th parking space ID obtained from the parking payment system and normalized at step 222;
W^{psen} may represent a assigned predefined weight of the parking sensors data source. The vehicle parking sensors data source; weight W^{ps} is in the range of (0-1), where 1 represents the highest weight and 0 represents the lowest weight;
Cᵢ^{psen} may represent the occupancy status confidence score of the i-th parking space ID obtained from the parking sensor and normalized at step 222;

The decision regarding whether the parking space ID is occupied or vacant may be taken by comparing the occupancy confidence score to a predefined threshold. For example, if the occupancy confidence score is higher than 50 than the occupancy status of parking space ID is set to occupied in the metropolitan area parking spaces database 260, else it is set to vacant.

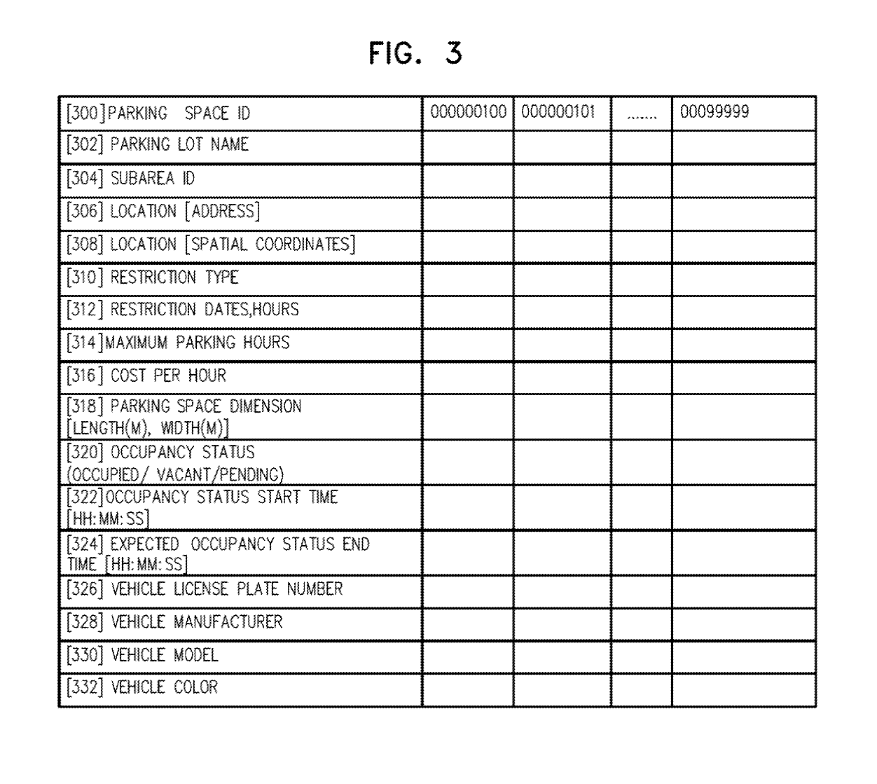

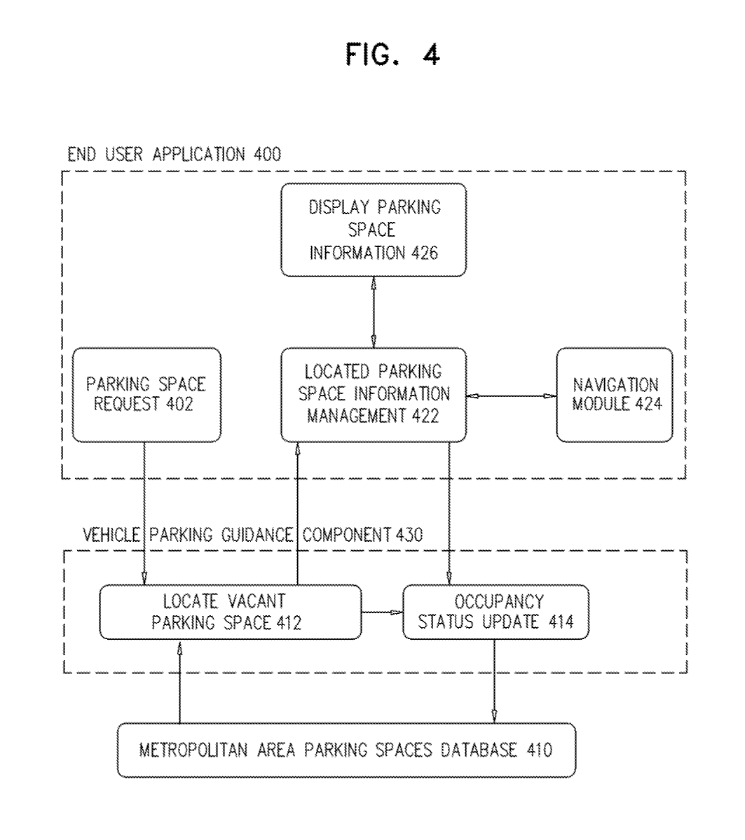

Reference is made to FIG. 3 which shows the metropolitan area parking spaces database structure, according to exemplary embodiments of the disclosed subject matter. The metropolitan area parking spaces database may represent a mapping schema of parking spaces and their associated attributes. The metropolitan area parking spaces database is updated in step 250 of FIG. 2 and by occupancy status update module 414 of FIG. 4. The columns on the metropolitan area parking spaces database represent different parking spaces, having a parking space ID, within the metropolitan area. The rows of the metropolitan area parking spaces database represent the different attributes of the parking spaces. Row 300 represents the parking space ID. The parking space ID is a unique identifier of a parking space within the metropolitan area parking spaces database. Row 302 represents parking lot name. The parking lot name may not be available in case that the parking space is not part of a parking lot. Row 304 represents parking space location aspects; subarea ID 302 is the metropolitan parking subarea in which the parking space is located. Rows 306 and 308 also represent parking space location attributes; parking space address 306 and spatial coordinates 308. Rows 310, 312 represent parking space metropolitan restrictions. Row 310 represents the restriction type of the parking space. The restriction types may include resident's vehicle restriction, public transportation vehicles restriction, disabled vehicle restriction or any other restriction. The parking space may not be restricted at all, unrestricted parking space may be indicated by assigning zero in the restriction type attribute. Row 312 represents the restriction dates and times. Maximum parking hours row 314 represent the maximum parking hours allowed in the parking space. Row 316 represents the cost per parking hour. Row 318 represents the parking space length and width dimensions in meters. Occupied/vacant/pending row 320 represents the occupancy status of the parking space. The parking space occupancy status may be occupied, vacant or pending. The occupancy status is updated in step 250 of FIG. 2 or by the occupancy status update module 414 of FIG. 4. Rows 322 and 324 represent the occupancy status start time and the occupancy status expected end time respectively. Rows 326, 328, 330 and 332 represent information that may exist regarding the parked vehicle; the information may include vehicle license plate number 326, vehicle manufacturer 328, vehicle model 330 and vehicle color 332.

Reference is made to FIG. 4 which shows a method for vehicle parking guidance, according to exemplary embodiments of the disclosed subject matter.

End user application component 400 may be software that is executed by designated navigation system hardware, a smart phone, a tablet computer or any other mobile computing device. The end user application component enables the end user to transmit a request for locating a vacant parking space. The end user application component may be able to display received information regarding a relevant vacant parking space. The end user application component consists of four modules: parking space request module 402, located parking space information management module 422, navigation module 424 and display parking space information 426.

Parking space request module 402 discloses sending parking space request by an end user application. The end user may be a vehicle driver that seeks for a vacant parking space in proximity to his driving destination. The parking space request may include the current location of the vehicle and the destination location which is the location of the requested parking space. The current location of the vehicle and the destination location of the requested parking space may be in the form of spatial location coordinates, street address or any other form. The parking space request may also include additional information such as the expected parking duration and the end user parking restrictions. The end user parking restrictions include information regarding the parking dates and time that the end user is restricted to park in each subarea of the metropolitan area. In addition, the parking space request may also include end user parking space cost limitation, such information may include the maximum amount per hour that the end user is willing to pay for parking in a parking space.

The parking space request is wirelessly transmitted by the parking space request module 402 and received by a vehicle parking guidance component 430. The vehicle parking guidance component's task is to send information regarding one or more vacant parking spaces upon receiving parking space requests from end users applications. The vehicle parking guidance component 430 consists of two modules: locate nearest vacant parking space module 412 and occupancy status update module 414.

The locate vacant parking space module 412 discloses a process of locating one or more vacant parking spaces upon parking space request in order to recommend them to the end user. The locate vacant parking space module 412 receives the parking space requests from the parking space request module 402. The parking space requests that are generated by the space request module 402, may include the current location of the end user and the destination location of the end user. It may also include the requested parking dimensions, the expected parking duration, the end user parking restrictions, the end user parking space cost limitation.

The vacant parking space location process is based on locating the nearest vacant parking space to the destination location of the end user. The location of the nearest vacant parking space is performed using the metropolitan area parking spaces database 410. The metropolitan area parking spaces database 410 is illustrated at FIG. 3. The database attributes such as occupancy status are updated according to step 250 of FIG. 2. The vacant parking space location process may also take into account the requested parking dimensions. Parking spaces with maximum parking hours attribute that is lower than the expected parking duration are excluded from the parking space location process. Parking spaces with smaller dimensions are excluded from the parking space location process. The vacant parking space location process may also take into account the expected parking duration. Parking spaces with maximum parking hours attribute that is lower than the expected parking duration are excluded from the parking space location process. The vacant parking space location process may also take into account the end user parking restrictions. For example, parking spaces in metropolitan subareas that are permitted at certain dates and/or hours for residents only are excluded from the parking space location process. The vacant parking space location may also take into account the end user parking space payment limitation and exclude from the parking space location process, parking spaces with higher cost per hour than the end user cost limitation. The output of this module is one or more located vacant parking spaces information. The located vacant parking space information includes the located vacant parking space location. In addition, the located vacant parking space may include additional information such as cost and/or restriction hours of the vacant parking space. The location information and the additional information may be extracted from the metropolitan area parking spaces database 410. The located vacant parking space information is wirelessly transmitted to vacant parking space information module 422.

Located parking space information management discloses the management of the located vacant parking space information. The located vacant parking space information module 422 produces additional information such as the driving distance from the current location of the end user and the vacant parking space. The distance from the current location of the end user and the vacant parking space may be produced by the navigation module 424. The vacant parking space information module 422 may also produce the estimated driving time to the vacant parking space. The estimated driving time may be produced by the navigation module 424, based on traffic information. The driving distance and the estimated driving time along with the located vacant parking space information produced by the locate vacant parking space module 412 are sent for display by the display parking space information module 426.

The display parking space information module 426 discloses displaying vacant parking space information to the end user. The display may include the one or more vacant parking spaces addresses. The display may also include the distance from the current location of the end user and the vacant parking space. It may also display the estimated driving time to the vacant parking space. The application may also display the cost per hour and restriction hours of the located vacant parking spaces. The display parking space information module may enable the end user to accept or reject a vacant parking space. The acceptance or rejection signal is wirelessly transmitted to the located parking space information management module.

Occupancy status update module 414 discloses the receiving of information from the locate vacant parking space module 412 and from the located parking space information management module 422 and updating the relevant occupancy status in the metropolitan area parking spaces database 410. Upon receiving information of the located vacant parking space from the locate vacant parking space module 412, the located vacant parking space's occupancy status is changed from vacant to pending. Pending occupancy status flags a parking space which is vacant but was located by the parking space location process and the vacant parking space information was sent to an end user. Upon receiving acceptance or rejection signal from vacant parking space information module 422, occupancy status update module 414 may toggle the occupancy status of a located parking space from pending to vacant.

The navigation module 424 may be navigation software such as GPS navigation software. The navigation module may be able to produce the distance between two input locations. For example, the distance between the current location of the end user and the located vacant parking space location may be produce upon receiving the two locations from vacant parking space information module 422. In addition, the navigation module may be able to produce the estimated driving time between two locations, based on traffic information.

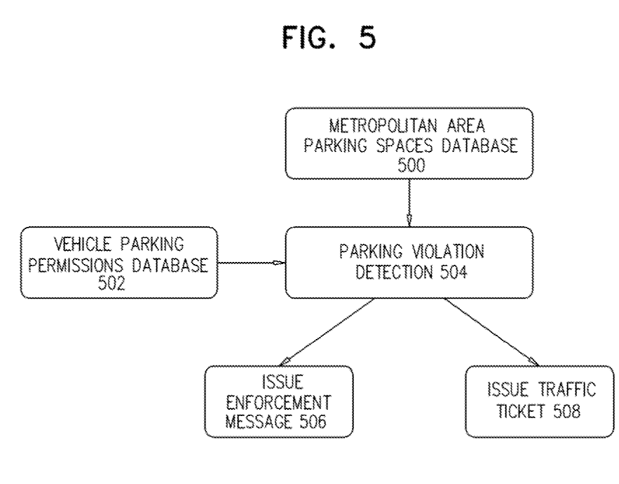

Reference is made to FIG. 5 which shows a method for managing vehicle parking violations, according to exemplary embodiments of the disclosed subject matter.

Step 500 discloses obtaining data related to metropolitan area parking spaces. Such data may be stored in a database as illustrated at FIG. 3. The Metropolitan area parking spaces database includes attributes such as the location of the parking space and the occupancy status of the parking space. It may also include information regarding the parked vehicle such as parked vehicle license plate number, parked vehicle manufacturer, model and color. The metropolitan area parking spaces database is updated in step 250 of FIG. 2 and by the occupancy status update module 414 of FIG. 4.

Step 502 discloses obtaining data related to vehicle parking permissions. Such data may be stored in a vehicle parking permissions database. The data related to vehicle parking permissions may include a list of vehicles and their parking permissions. Each vehicle's identifier on the list includes license plate numbers, vehicle manufacturer, model and color. Personal information of the vehicle owner such as full name, mail address, email address, telephone number, cellular phone number and driver's license number is associated to each vehicle on the list. Parking permission information is also associated to each vehicle on the list. The parking permission information includes restricted parking spaces in which the vehicle is permitted to park. The restricted parking spaces may include “residents only” parking spaces, disabled parking spaces and the like. The permitted restricted parking space IDs may be represented in the vehicle parking permissions database as specific parking space IDs. The permitted restricted parking space IDs may also be grouped together and represented in the vehicle parking permissions database as one or more metropolitan subarea identifiers. The vehicle parking permissions database may be updated and managed by a metropolitan area authority such as a city municipality or a metropolitan police.

Step 504 discloses detecting parking violations. Data regarding the occupancy statuses and regarding the parked vehicles is obtained from the metropolitan area parking spaces database at step 500. The data regarding the occupancy statuses and regarding the parked vehicles is compared to the vehicle parking permissions data that is obtained at step 502. The occupancy statuses data and the parked vehicles data may originate from cameras data 200 of FIG. 2. The occupancy statuses may be detected in parking occupancy status detection step 204 of FIG. 2. The parked vehicles data may be extracted in vehicle information extraction step 206 of FIG. 2. The occupancy statuses data and the parked vehicles data may also originate from additional sources such as vehicle parking payment systems or social media applications.

The metropolitan area parking spaces database is searched for occupied restricted parking spaces. Restricted parking spaces may be indicated by a non-zero value in the restricted type attribute of the parking space. The restricted parking space ID and the license plate number of the parked vehicle are extracted from the metropolitan area parking spaces database. The relevant parking permission information is extracted from the vehicle parking permissions database according to the extracted license plate number. Parking violation may be detected by comparing the extracted restricted parking space ID and the extracted parking permission information. For example, if the parking space ID of the restricted parking space is not contained in the list of restricted parking spaces that are permitted for the parked vehicle then a parking violation is detected. The parking violation detection may also take into account the parking restriction dates and times by comparing the current date and time and the parking restriction dates and times.

Step 506 discloses issuing a parking violation enforcement message. A parking violation enforcement message may be sent upon parking violation detection according to step 504. The parking violation enforcement message may be sent to parking violation enforcement personnel such as municipal parking inspectors or police officers. The parking violation enforcement message includes information regarding the parking violation. Said information includes the location of the parking space. It may also include information such as license plate number, manufacturer, model and color of the parked vehicle. The parking violation enforcement message may be sent by means of cellular data network, law enforcement data network or any other data communication network.

Step 508 discloses issuing a traffic ticket. A traffic ticket may be issued upon the detection of a parking violation as disclosed in step 504. The traffic ticket may include information regarding the parking violation such as the parking place location, date and time of the violation, license plate number, manufacturer, model and color of the parked vehicle. The traffic ticket may include information regarding a fine amount, the payment method and the payment deadline. The traffic ticket may be sent by mail, email or any other way of communication. Information regarding the recipient of the traffic ticket is extracted from the vehicle parking permissions database. The information regarding the recipient of the traffic ticket may include full name, mail address, email address, phone number, cellular phone number and the like.

1. A method for vehicle parking spaces management using image processing, comprising:
obtaining one or more images of a plurality of parking spaces, segmenting the image of the one or more images to represent a parking space per segmented image;
detecting parked vehicles in the segmented image using image processing;
obtaining data from one or more additional sources related to the occupancy status of the plurality of parking spaces; and
evaluating the occupancy status of the parking space of the plurality of parking spaces based on the parking vehicle detection and the obtained data from the one or more additional sources.

2. The method according to claim 1, wherein the one or more images are obtained from one or more street cameras.

3. The method according to claim 1, wherein the one or more images are obtained from one or more satellite cameras.

4. The method according to claim 1, wherein the data from the additional sources related to the occupancy status of a plurality of parking spaces is obtained from a computerized application, wherein data in the computerized application is provided from users of the computerized application.

5. The method according to claim 1, wherein the data from the additional sources related to the occupancy status of a plurality of parking spaces is obtained from one or more vehicle parking payment systems.

6. The method according to claim 1, wherein the data from the additional sources related to the occupancy status of a plurality of parking spaces is obtained from a plurality of parking sensors.

7. The method according to claim 6, further comprises assigning weights to the obtained data from the one or more additional data sources.

8. The method according to claim 3, further comprises assigning weights to the one or more street cameras and to the one or more satellite cameras.

9. The method according to claim 8, further comprises generating occupancy confidence score based on the parking vehicle detection and the obtained data from the one or more additional data sources; said confidence score represents the probability estimation that the parking space is occupied.

10. The method according to claim 9, wherein the occupancy confidence score generation is further based on the weights assigned to the one or more street cameras, to the one or more satellite cameras and to the one or more additional data sources.

11. The method according to claim 10, further comprises generating an occupancy decision based on the occupancy confidence score.

12. The method according to claim 11, further comprises updating the occupancy status in a metropolitan area parking spaces database based on the occupancy decision.

13. The method according to claim 1, further comprises vehicle information extraction using image processing.

14. The method according to claim 13, further comprises updating the metropolitan area parking spaces database with the extracted vehicle information.

15. The method according to claim 14, further comprises:
receiving a parking space request from an end user of a mobile computing device;
locating one or more vacant parking spaces in the metropolitan area parking spaces database to be recommended to the end user of the mobile computing device; and
transmitting parking space information to the mobile computing device, said parking space information comprises data regarding the located vacant parking space.

16. The method according to claim 15, wherein the location of the vacant parking space is based on locating the nearest vacant parking space to the destination location of the end user.

17. The method according to claim 16, wherein the location of the vacant parking space is further based on the end user's expected parking duration, the end user's parking restrictions and the end user's parking space cost limitation.

18. The method according to claim 14, further comprises:
obtaining parking occupancy statuses, parked vehicles information and parking space restriction information; and
detecting parking violations based on the said parking occupancy statuses, parked vehicles information and parking space restriction information.

19. The method according to claim 18, further comprises issuing parking violation enforcement message based on the detection of the parking violation.

20. The method according to claim 18, further comprises issuing a traffic ticket based on the detection of the parking violation.
